(19) United States
(12) Patent Application Publication
(10) Pub. No.: US 2025/0130740 A1
(43) Pub. Date: Apr. 24, 2025

(54) PULL-PRINTING SYSTEM, METHOD FOR CONTROLLING MOBILE TERMINAL IN PULL-PRINTING SYSTEM AND STORAGE MEDIUM

(71) Applicant: CANON KABUSHIKI KAISHA, Tokyo (JP)

(72) Inventor: HIDEKI HANANO, Kanagawa (JP)

(21) Appl. No.: 18/918,670

(22) Filed: Oct. 17, 2024

(30) Foreign Application Priority Data
Oct. 23, 2023 (JP) 2023-182052

(51) Int. Cl. G06F 3/12

(52) U.S. Cl. CPC G06F 3/1204; G06F 3/1222; G06F 3/1236; G06F 3/1238; G06F 3/1288

(57) ABSTRACT

The present pull-printing system comprises a printing apparatus, a printing server, and a mobile terminal and executes printing of a print job, which has been submitted to the printing server, using the printing apparatus, based on an instruction of the mobile terminal. The printing server receives and stores a print job submitted by a user, identifies the user, and transmits information related to the print job in a push notification to a notification destination mobile terminal associated with the user. Upon receiving the push notification, the mobile terminal instructs execution of the print job based on an operation on the message displayed on a display unit, and upon receiving the instruction to execute the print job, the printing server transmits the print job to the printing apparatus associated with the user and executes printing.

### BACKGROUND OF THE INVENTION

### Field of the Invention

The present invention relates to a pull-printing system, a method for controlling a mobile terminal in the pull-printing system and a storage medium.

### Description of the Related Art

In recent years, Multi Function Peripherals (MFPs) having both a function of printing electronic data on a paper surface and a function of reading (scanning) a paper document and generating electronic data have been supplied at low costs. These MFPs have come to be widespread not only in offices but also in regular homes. Some MFPs have a function of connecting to a network.

Meanwhile, Japanese Patent No. 6237576 proposes a pull-printing system in which print jobs are managed on a server based on user authentication information and printing is executed by an image forming apparatus through the server.

In pull printing, a user selects a printer and gives a print instruction, but a print job (print data) is stored on a server. Upon the user issuing an instruction to output a print job from the printer that the user selected, the printer makes a print job request to a printing service and downloads the print job and thereby performs actual printing output.

Pull printing in which when printing a job submitted to a server, only a print job selected on an operation panel of a printer is printed is excellent in terms of security. However, there are systems in which, since pull printing is less convenient than push printing in which a submitted job is immediately printed, pull printing and push printing can be switched depending on the intended use.

Further, some low-cost printers (image forming apparatuses) for regular homes may not be provided with an operation panel, or even if an operation panel itself is provided, the operation panel may be small. For this reason, it is conceivable to use a smartphone as an alternative to an operation panel of a printer.

In the above-described related art, when pull printing is performed using a smartphone, there are many user operations, such as activation of an application on the smartphone, selection of a printing service to be used, selection of a function, and selection of a print job, and so, user convenience is low.

### SUMMARY OF THE INVENTION

The present invention enables realization of a pull-printing technique in which user convenience has been improved.

One aspect of the present invention provides a pull-printing system comprising a printing apparatus, a printing server, and a mobile terminal, the pull-printing system operable to execute printing of a print job, which has been submitted to the printing server, using the printing apparatus, based on an instruction of the mobile terminal, the printing server comprising: one or more first memory devices that store a set of instructions; and one or more first processors that execute the set of instructions to: receive a print job submitted by a user; store the print job; identify the user who submitted the received print job, and transmit information related to the print job in a push notification to a notification destination mobile terminal associated with the user; and transmit the stored print job to the printing apparatus associated with the identified user, and the mobile terminal comprising: a display unit; one or more second memory devices that store a set of instructions; and one or more second processors that execute the set of instructions to: receive the push notification from the printing server; and in a case where the push notification is received, display a message on the display unit; and transmit an instruction to execute the print job to the printing server based on a user operation on the message, wherein the printing server transmitting the print job stored in the printing apparatus is transmitting the print job to the printing apparatus upon receiving an instruction to execute the print job.

Another aspect of the present invention provides a method for controlling a mobile terminal in a pull-printing system including a printing apparatus, a printing server, and the mobile terminal, wherein the pull-printing system is configured to execute printing of a print job, which has been submitted to the printing server, using the printing apparatus based on an instruction of the mobile terminal, the method comprising: receiving, from the printing server, information related to the print job and information for identifying a pull-printing application of the mobile terminal through a push notification; in a case where the push notification is received, displaying a message on the display unit; causing the pull-printing application to display, on the display unit, an operation screen for performing an operation on the print job according to a user operation on the message; and transmitting an instruction to execute the print job to the printing server based on a user operation in the operation screen,

Still another aspect of the present invention provides a non-transitory computer-readable storage medium, the storage medium storing a program for causing a computer to execute each step of a method for controlling a mobile terminal in a pull-printing system, wherein the pull-printing system includes a printing apparatus, a printing server, and the mobile terminal and is configured to execute printing of a print job, which has been submitted to the printing server, using the printing apparatus, based on an instruction of the mobile terminal the method comprising: receiving, from the printing server, information related to the print job and information for identifying a pull-printing application of the mobile terminal through a push notification in a case where the push notification is received, displaying a message on the display unit; causing the pull-printing application to display, on the display unit, an operation screen for performing an operation on the print job according to a user operation on the message; and transmitting an instruction to execute the print job to the printing server based on a user operation in the operation screen.

Further features of the present invention will be apparent from the following description of exemplary embodiments with reference to the attached drawings.

### BRIEF DESCRIPTION OF THE DRAWINGS

FIG. 1 is a diagram illustrating an example of a configuration of a pull-printing system.

FIG. 2 is a block diagram illustrating a schematic configuration of an MFP.

FIG. 3 is a block diagram illustrating a schematic configuration of a client apparatus, a relay server, a printing server, and a mobile terminal.

FIGS. 4A to 4D are diagrams illustrating examples of display screens of a printing application of the mobile terminal.

FIG. 5A is a sequence diagram for explaining scan processing.

FIG. 5B is a sequence diagram for explaining print processing.

FIG. 6 is a flowchart for explaining processing for switching screen display after activation of the printing application in the mobile terminal.

FIG. 7 is a sequence diagram for performing user authentication and authorization and obtaining data of the printing server.

FIGS. 8A to 8C are diagrams illustrating examples of print setting screens of the mobile terminal.

FIGS. 9A to 9C are diagrams illustrating examples of printing management service screens of the client apparatus.

FIG. 10 is a sequence diagram in which the MFP obtains a list of print jobs of the printing server.

FIGS. 11A and 11B are diagrams illustrating examples of screens for displaying a list of print jobs of the MFP.

FIGS. 12A and 12B are diagrams illustrating examples of a screen for displaying a print dialog and a screen for selecting a print job submission method in the client apparatus.

FIG. 13 is a sequence diagram for performing push printing.

FIGS. 14A and 14B are diagrams illustrating examples of screens for setting a push notification in the mobile terminal.

FIG. 15 is a sequence diagram for registering push notification settings for when the mobile terminal has set a push notification.

FIG. 16 is a sequence diagram from when pull-printing job is submitted to when push notification is performed in a first embodiment.

FIGS. 17A to 17C are diagrams illustrating examples of mobile terminal screens for when a push notification is received.

FIGS. 18A and 18B are sequence diagrams for performing pull printing in one embodiment.

FIGS. 19A and 19B are sequence diagrams for performing pull printing in one embodiment.

FIG. 20A is a diagram illustrating an example of a print code issuance screen of the client terminal according to one embodiment.

FIG. 20B is a diagram illustrating examples of a print code input screen of the client terminal according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

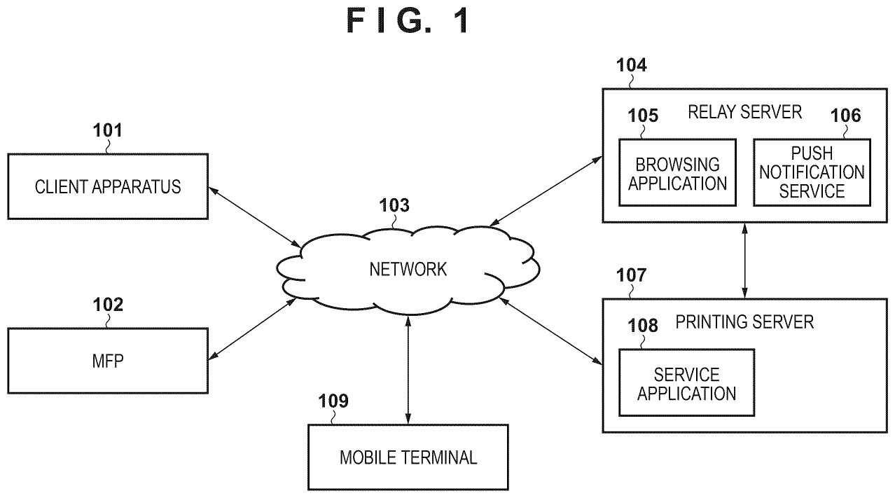

A configuration of a pull-printing system including a relay server according to the present embodiment will be described with reference to FIG. 1. The pull-printing system of FIG. 1 includes a client apparatus 101, a Multi Function Printer (MFP) 102, a relay server 104, a printing server 107, and a mobile terminal 109. The relay server 104 and the printing server 107 each are connected to the client apparatus 101, the MFP 102, and the mobile terminal 109 via a network 103.

The network 103 may be, for example, a Local Area Network (LAN), Wide Area Network (WAN), a telephone line, or a dedicated digital line. The network 103 may be, for example, an Asynchronous Transfer Mode (ATM) network, a frame relay line, a cable television line, a wireless line for data broadcasting, and the like. Alternatively, the network 103 may be, for example, a so-called communication network such as the Internet realized by a combination of these.

The client apparatus 101 and the MFP 102 are connected to the network 103 by an access point. The client apparatus 101 and the MFP 102 are provided with a web browser and each display a web service provided by the relay server 104 on a browser screen so as to allow a user to use the pull-printing system.

The relay server 104 is a relay server that relays transmission and reception of data for use of a service provided by a service application 108 (to be described later) in response to access from the client apparatus 101, the MFP 102, and the mobile terminal 109. In the relay server 104, a browsing application (browsing application 105) for managing browsing of web pages by the client apparatus 101, the MFP 102, and the mobile terminal 109 is implemented.

Hereinafter, description will be given collectively referring to the client apparatus 101, the MFP 102, and the mobile terminal 109 as a client terminal. As will be described later, a web browser provided in the client terminal displays a web page so as to allow the user to browse the web page, but in the present specification, description may be given in a simplified manner, such as “the client terminal displays a web page”.

The relay server 104 includes functions of the browsing application 105 and a push notification service 106. The browsing application 105 realizes a function of managing browsing of a web page by the user in a web browser. The browsing application 105 returns a predetermined web page in response to access from the client terminal. Predetermined web pages include web pages related to various services provided by the printing server 107. In the present embodiment, the client terminal obtains a web page related to various kinds of information provided by the printing server 107, not directly from the printing server 107 but through the browsing application 105, and displays the web page. That is, the client terminal displays a web page provided by the browsing application 105 and thereby allows the user to browse various kinds of information indirectly provided by the printing server 107.

For example, the client terminal includes information of a list of print jobs managed by the printing server 107 in a web page provided by the browsing application 105 and thereby allows the user to browse the information. The predetermined web pages include a service login page for logging in to the printing server 107 from the client terminal. The service login page is a web page provided by the printing server 107.

The push notification service 106 cooperates with a push notification server provided by a company that develops an operating system (OS) of the mobile terminal 109, activates an application of the mobile terminal 109 using a push notification, and displays a message. For example, as a service corresponding to iOS® provided by Apple Inc., there is Apple Push Notification service (APNs). When the OS of the mobile terminal 109 is iOS, an APNs server is used as the push notification server. In addition, as a service corresponding to Android® provided by Google Inc., there is Firebase Cloud Messaging (FCM). When the OS of the mobile terminal 109 is Android, an FCM server is used as the push notification server.

The printing server 107 provides a predetermined service to the client terminal via the relay server 104. In the printing server 107, an application 108 for providing the client terminal with the predetermined service is implemented. Hereinafter, the “application for providing the predetermined service” will be referred to as the “service application”. In the client terminal, a service provided by the service application 108 is used via the relay server 104.

In the present embodiment, the service application 108 manages data, such as image data and document files owned by the user, for example, on the printing server 107. The service application 108 provides a service that allows browsing of those files on a web browser or another Graphical User Interface (GUI).

Further, the service application 108 provides a service for uploading image data or a document file designated through the relay server 104 or directly from the client terminal to the printing server 107. In addition, the service application 108 provides a service capable of providing and updating file information via an Application Programming Interface (API).

The services provided by the service application 108 are not limited to this, and various known services may be provided. In order to use the service application 108, it is necessary to log in using account information registered in advance. In the present embodiment, login means input and authentication of general account information and obtainment of authentication information. Login may be performed using commonly known OAuth authorization. Alternatively, login may be performed using a method in which a Personal Identification Number (PIN) code issued by the service application 108 is inputted on the client terminal. In addition, login may be performed by another method so long as it is a method by an account registered in advance can be identified.

In the present embodiment, the browsing application 105 implemented in the relay server 104 transmits a web page to the client terminal and thereby causes the client terminal to display the web page. This makes it possible for the user to view the web page displayed on the client terminal. In addition, the browsing application 105 can perform processing for logging into the service application 108 in response to a user operation on the client terminal on the displayed web page.

Further, after login processing, the browsing application 105 obtains information related to a service provided by the service application 108 by using authentication information, generates a web page in which the service can be used, and transmits the web page to the client terminal. As described above, in the pull-printing system of FIG. 1, the relay server 104 in which the browsing application 105 is implemented communicates with the printing server 107 in which the service application 108 is implemented and transmits a result thereof to the client terminal.

The client apparatus 101 may be any terminal so long as it is a terminal on which a web browser can be provided such as a smartphone, a tablet, or a general-purpose personal computer. The mobile terminal 109 is exemplified by a smartphone. A smartphone is a multifunctional mobile phone provided with a camera, a web browser, an electronic mail function, and the like in addition to the functions of the mobile phone. The mobile terminal to which the present disclosure is applicable is not limited to a smartphone and may be a portable terminal such as a tablet, a Personal Digital Assistant (PDA), a notebook computer, or the like.

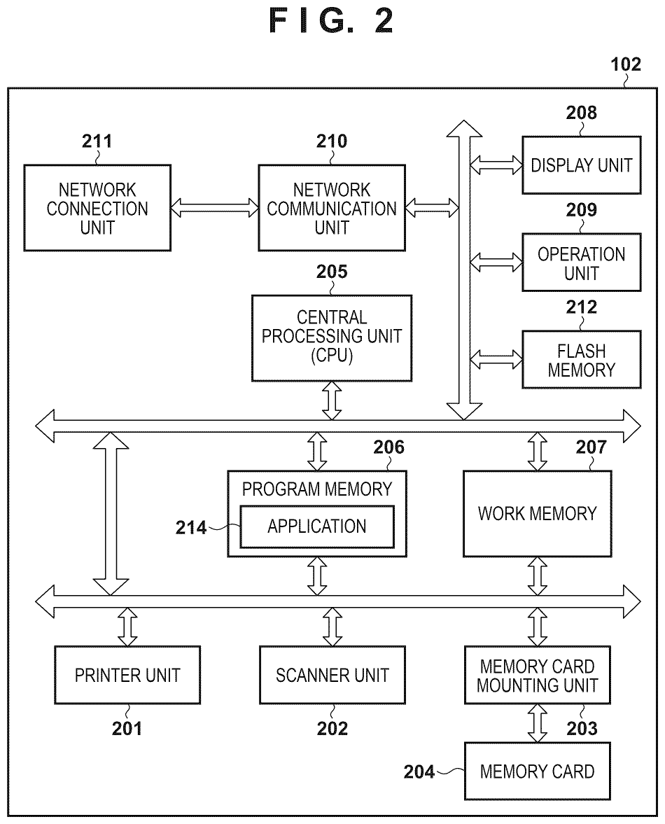

Next, a configuration of the MFP 102 will be described with reference to FIG. 2. In the present specification, an MFP will be described exclusively as an example of a peripheral apparatus, but the type of apparatus does not matter so long as it is provided with a printing apparatus and is capable of performing printing on a paper medium, such as an image forming apparatus, an image processing apparatus, a copying machine, or a facsimile machine.

In the MFP 102, a print function is realized by a printer unit 201, a scanner function is realized by a scanner unit 202, and a storage function is realized by a memory card mounting unit 203 and a memory card 204. The printer unit 201 prints image data received from the outside, image data stored in the memory card 204, and the like on a printing sheet using a printing method such as an inkjet method or an electrophotographic method. In addition, ink information including the remaining amount of ink and sheet information including the number of stacked sheets are also managed.

The scanner unit 202 optically reads a document set on a document table (not illustrated) and converts a result into electronic data. Then, image data converted into a designated file format is transmitted to an external apparatus through the network 103 or stored in a storage region (not illustrated) such as an HDD. Further, a copy service is realized by image data generated by the scanner unit 202 reading a document placed on the document table being transferred to the printer unit 201 and the printer unit 201 printing the image data on a printing sheet.

Various kinds of file data are stored in the memory card 204 mounted in the memory card mounting unit 203. The file data may be read by an external apparatus via a network, and the file data may be editable by that external apparatus. The file data can also be stored in the memory card 204 from an external apparatus.

Further, the MFP 102 includes a CPU 205, a program memory 206, a work memory 207, a display unit 208, an operation unit 209, a network communication unit 210, a network connection unit 211, and a flash memory 212.

The CPU 205 is a central processing unit for controlling each unit in the MFP 102. The program memory 206 is constituted by a ROM or the like and stores various kinds of program code and an application 214 for communicating with a server apparatus. The application 214 accesses the printer unit 201 and obtains information on consumables such as ink and sheets.

The work memory 207 is constituted by a RAM or the like and temporarily stores and buffers image data and the like at the time of execution of respective services. The CPU 205 reads a program stored in the program memory 206 into the work memory 207 and executes the program.

The display unit 208 is constituted by, for example, an LCD, and displays various kinds of information. The operation unit 209 is constituted by a switch and the like for the user to perform various input operations.

The network communication unit 210 connects the MFP 102 to the network and performs various kinds of communication. The network communication unit 210 can be connected to the network 103 such as the Internet via the network connection unit 211. The network communication unit 210 supports a wired LAN and a wireless LAN. The network connection unit 211 is a connector for connecting a cable of a wired LAN in a case where a wired LAN is supported, and the network connection unit 211 is an antenna in a case where a wireless LAN is supported.

The flash memory 212 is a non-volatile memory for storing image data and the like received by the network communication unit 210. The respective units described above are connected to each other via a bus 213.

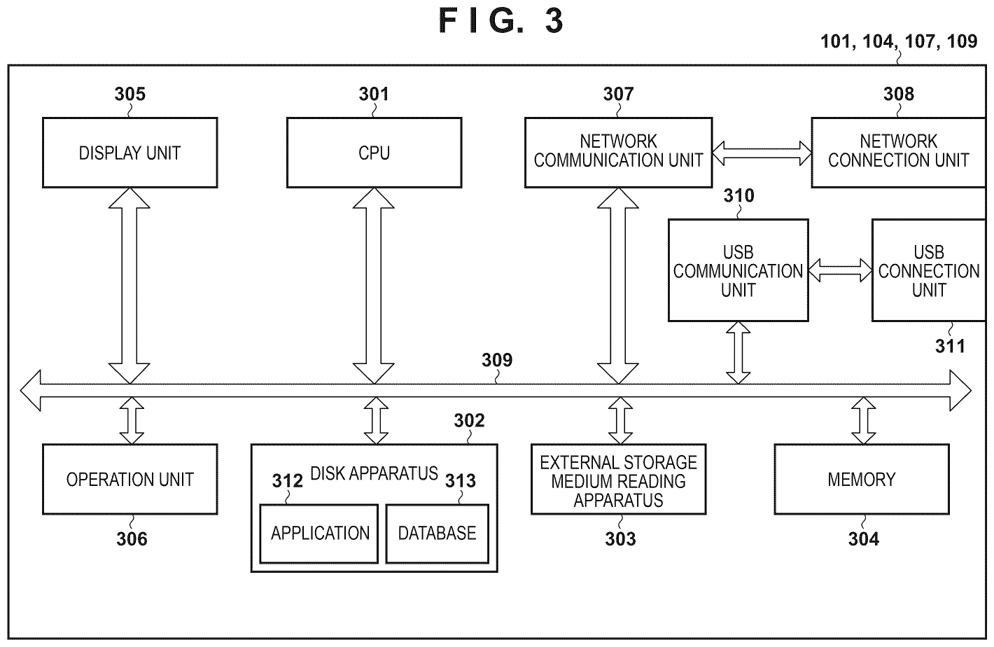

Next, a schematic configuration of the client apparatus 101, the relay server 104, the printing server 107, and the mobile terminal 109 will be described with reference to FIG. 3.

A CPU 301 is a central processing unit for controlling each of the following units.

A disk apparatus 302 stores various files in addition to an application program 312, a database 313, and an OS to be read by the CPU 301. An external storage medium reading apparatus 303 is an apparatus for reading information such as a file stored in an external storage medium such as an SD card.

A memory 304 is constituted by a RAM or the like, and the CPU 301 temporarily stores and buffers data therein as needed, for example. A display unit 305 is constituted by, for example, an LCD, and displays various kinds of information. An operation unit 306 is constituted by a keyboard, a mouse, and the like for the user to perform various input operations.

A network communication unit 307 is connected to a network such as the Internet via a network connection unit 308 and performs various kinds of communication. The network communication unit 307 supports a wired LAN and a wireless LAN. The network connection unit 308 is a connector for connecting a cable of a wired LAN in a case where a wired LAN is supported, and the network connection unit 308 is an antenna in a case where a wireless LAN is supported.

A USB communication unit 310 is connected to various peripheral apparatuses via a USB connection unit 311 and performs various kinds of communication.

The respective units described above are connected to each other via a bus 309. The client apparatus 101, the relay server 104, and the printing server 107 may be virtual computers implemented on another computer.

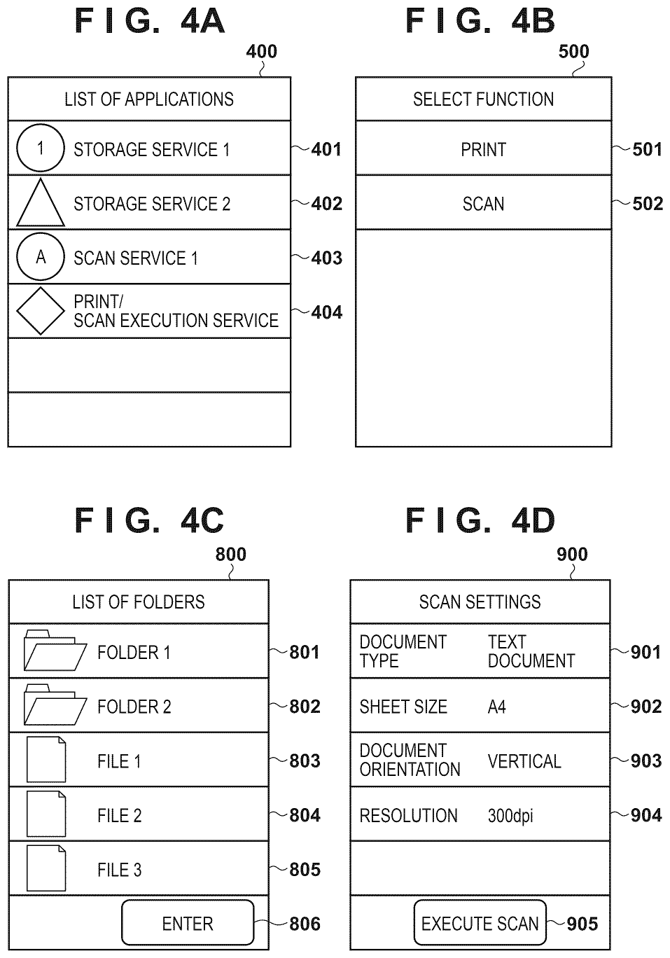

Next, processing in a case where printing or scanning is performed by the client terminal will be described. When the client apparatus 101 or a web browser of the MFP 102 accesses the browsing application 105 of the relay server 104, an application list 400 is displayed on the display unit 305 or 208. An example of a screen of the application list 400 is illustrated in FIG. 4A. In the application list 400, four service names 401, 402, 403, and 404 are displayed as options.

These service names indicate services realized by the printing server 107. A plurality of services (e.g., 401 and 403) may be realized by a single printing server, or for some or all of the services, the same server may have functions of both the relay server 104 and the printing server 107. A symbol arranged on the left side of each service name represents an icon by which that service name can be identified as an image.

Further, the relay server 104 itself may have functions of a push notification server. Furthermore, the same server may also have all the functions of the printing server 107, the relay server 104, and the push notification server. In the present specification, a server having all of these functions may be simply referred to as a printing server.

The relay server 104 cooperates with these services to realize an application function of printing a document or an image obtained from a corresponding service using the MFP 102 or transmitting a document or an image scanned by the MFP 102 to a corresponding service.

Here, as a printing application, an application for printing a document or an image stored in the printing server 107, which provides a storage service or an image sharing service, may be considered. Further, a print job execution application or the like capable of displaying a print job managed in the printing server 107 and performing print execution is conceivable.

Here, a “print job” refers to a combination of print data obtained from the printing application and print settings set by the user.

As a scanning application, a storage application for storing a scan result in the printing server 107, which provides a storage service, can be considered. As the scanning application, a profile execution application or the like that processes a scan result in accordance with a processing method registered in the printing server 107 may be considered. Individual applications may have both print and scan functions or may be configured to perform only one of the functions.

In the application list 400, it is desirable to only allow selection of applications that can be used by the user in the MFP 102. For example, when the user is prohibited from using the scan function in the MFP 102 or when the MFP 102 does not have the scan function, the client apparatus 101 prohibits selection of or hides scan service 1 (403).

Here, when an application supporting both the print and scan functions is selected by the user, the client apparatus 101 may display a screen for selecting one of the functions, which is illustrated in FIG. 4B, after the application has been activated and allow use of a function selected by the user. In this case, only available functions may be made selectable as in the application list 400 described above.

For example, when the user is prohibited from using the scan function in the MFP 102 or when the MFP 102 does not have the scan function, the client apparatus 101 prohibits selection of or hides a scan menu 502. Further, when the scan menu 502 is hidden, the only selectable menu will be a print menu 501, and therefore, the client apparatus 101 may skip display of a function selection screen 500 and display a screen in a state after the print menu 501 has been selected.

A flowchart to be executed by the browsing application 105 of the relay server 104 after the application list 400 is displayed will be described with reference to FIG. 6. In the following, step numerals of respective processes included in the flowchart of FIG. 6 will be indicated using numerals starting with “S”. It is similar for subsequent flowcharts.

Upon receiving (step S601) selection of one of the applications by a user operation on the application list 400 via the operation unit 306 or 209, the browsing application 105 receives information indicating the selected application from the client terminal.

The browsing application 105 determines whether the selected application is an application supporting printing and scanning and, in the case of an application supporting printing and scanning, transitions (step S602) to step S607 and, in the case of an application supporting either one, transitions (step S602) to step S603.

When the selected application is an application supporting either printing or scanning, the browsing application 105 determines whether the application selected in step S603 is a printing application. The browsing application 105, in the case of a printing application, transitions the processing to step S610 and, in the case of a scanning application, transitions the processing to step S604.

Steps 604 to S606 are a scanning flow for executing scanning. In step S604 a folder selection screen is displayed and a folder is selected, in step S605 a scan setting screen is displayed and scan setting is performed, and then in step S606 scanning is performed. With this, the scanning flow is completed. Here, an example in which a folder is selected in step S604 has been described; however, in a case of a service in which scanning is executed according to a profile, in step S604 a scan profile is selected

Steps 610 to S612 are a printing flow for executing printing. In step S610 a file selection screen is displayed and a print file is selected, in step S611 a print setting screen is displayed and print setting is performed, and then in step S612 printing is performed. With this, the printing flow is completed.

If the application selected in step S602 has both print and scan functions, it is further determined (step S607) whether the user can use both print and scan functions. If only one of the function can be used, the processing proceeds to step S613, and if both functions can be used, the processing proceeds to step S608. The determination here is made using information such as whether the MFP 102 being used supports both the print and scan functions and whether the user is permitted to use both the print and scan functions as an account of the printing server 107. Whether the user is permitted to use both the print and scan functions may be set in advance by an administrator of the account.

In step S613, it is determined which of the print and scan functions can be used, and if the print function can be used, the above-described printing flow from step S610 onward is executed, and if the scan function can be used, the above-described scanning flow from step S604 onward is executed.

In step S608, a print and scan function selection screen illustrated in FIG. 4B is displayed. Then, if the print function is selected in step S609, the above-described printing flow from step S610 onward is executed, and if the scan function is selected, the above-described scanning flow from step S604 onward is executed.

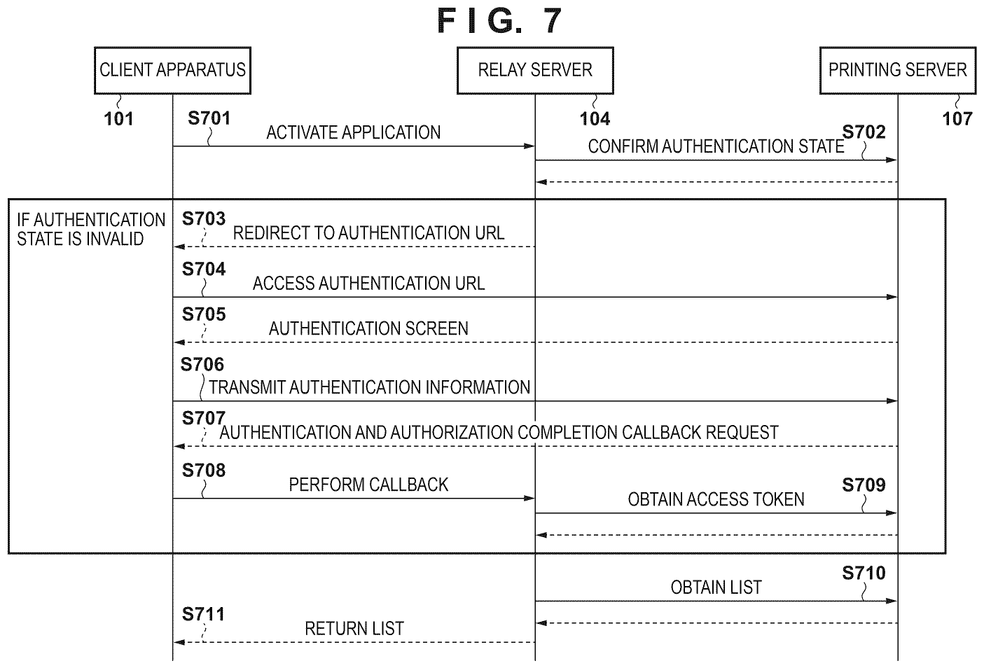

Processing for performing user authentication and authorization and obtaining data of the printing server will be described with reference to FIG. 7. Regarding the printing server 107 and the relay server 104, their web services cooperate to realize processing for the user to obtain and upload files. Then, user authentication and authorization is performed for the printing server 107, and a screen for selecting a list of folders, print jobs, and the like held by the user is displayed.

Description will be given using a generally-known OAuth authorization as an example of authorization processing. In OAuth authorization, the relay server 104 serves as a client, and the printing server 107 serves as a resource server. Here, description will be given assuming that the user uses the browsing application 105 of the relay server 104 by using the display unit 305 and the operation unit 306 of the client apparatus 101. The mobile terminal 109 may be used instead of the client apparatus 101.

When any one of the applications is selected from the application list 400 by the operation unit 306 of the client apparatus 101, the client apparatus 101 requests (step S701) the relay server 104 to activate the selected application. Then, the relay server 104 confirms (step S702) a held authentication state with the printing server 107.

In step S702, if the printing server 107 determines that the authentication state is invalid, the relay server 104 transmits (step S703) a request to redirect to a URL for authenticating with the printing server 107 to the client apparatus 101. This is a case where authentication information for when authentication was previously performed is expired or a case where the printing server 107 is accessed for the first time.

The client apparatus 101 accesses (step S704) the URL for authenticating with the printing server 107 in accordance with the received redirection request and displays (step S705) an authentication screen on the display unit 305 of the client apparatus 101.

In the authentication screen, the client apparatus 101 obtains, from the user, information (e.g., account ID and password) for authenticating with the printing server 107 and transmits (step S706) the information to the printing server 107. With this, the printing server 107 transmits (step S707) a post-authentication-completion callback request to the client apparatus 101. In response, the client apparatus 101 transmits (step S708) callback information to the relay server 104.

Here, if the user who has performed the authentication has not completed the authorization processing for using functions provided by the printing server 107, the flow of steps S705 and S706 is performed again. Then, an authorization screen is redirected to, a permission screen for obtaining permission for necessary items from the user is displayed, and permission information of the user is transmitted to the printing server 107.

Upon receiving the callback information from the client apparatus 101, the relay server 104 completes an authentication and authorization operation in a normal manner. Based on the callback information received from the client apparatus 101, the relay server 104 obtains (step S709) an access token necessary for obtaining information of an account for which authentication has been performed from the printing server 107.

Then, the relay server 104 uses the access token obtained from the printing server 107 to obtain (step S710), from the printing server 107, folder information, a list of print jobs, and the like of the printing server 107 associated with the authenticated account. Then, the relay server 104 returns (step S711) the list obtained from the printing server 107 to the client apparatus 101. The client apparatus 101 generates a screen for displaying a list of folders and files and print jobs on the display unit 305.

FIG. 4C is an example of a screen for displaying a list of folders and files. In FIG. 4C, folder 1 (801) and folder 2 (802) indicate folders owned by the user on the printing server 107. File 1 (803), file 2 (804), and file 3 (805) indicate files arranged in the same hierarchy as folder 1 (801) and folder 2 (802).

At execution of the scanning application or at execution of the scan function in an application capable of performing printing and scanning, the user is prompted to select a folder to be an upload destination of a scan result by an operation on the operation unit 306. In this case, file 1 (803), file 2 (804) and file 3 (805) cannot be selected. Files, which cannot be selected, may be hidden.

When one of the folders is selected, the selected folder information is transmitted from the client apparatus 101 to the relay server 104. Accordingly, the processing of steps S710 and S711 is performed again, and a folder and file list display screen 800 is updated so as to display subfolders and files in the selected folder.

Then, when the user operates an enter button 806, a folder being displayed at that time is selected as the upload destination folder. In the state of FIG. 4C, a folder containing folder 1 (801), folder 2 (802), and files 1 to 3 is selected as the upload destination folder.

At execution of the printing application or at execution of the print function in an application capable of performing printing and scanning, the user is prompted to select a file to be printed by an operation on the operation unit 306. At this time, if a folder (801 or 802) is selected, subfolders and files in that folder are displayed similarly to when the scan function is executed. In addition, since it is necessary to identify a file to be printed at execution of the print function, the enter button 806 is enabled only in a state in which a file is selected.

When the user selects the enter button 806 in FIG. 4C at execution of the scan function, a screen for performing scan setting of FIG. 4D is transitioned to. In FIG. 4D, a document type (901), a sheet size (902), a document orientation (903), and a resolution (904) are exemplified as items that can be set for scanning. A scan setting item may be any item so long as it is an item that can be set in the MFP 102, and in a case where scanning is executed in a state which the values of all items are fixed, a configuration in which no setting is performed may be taken.

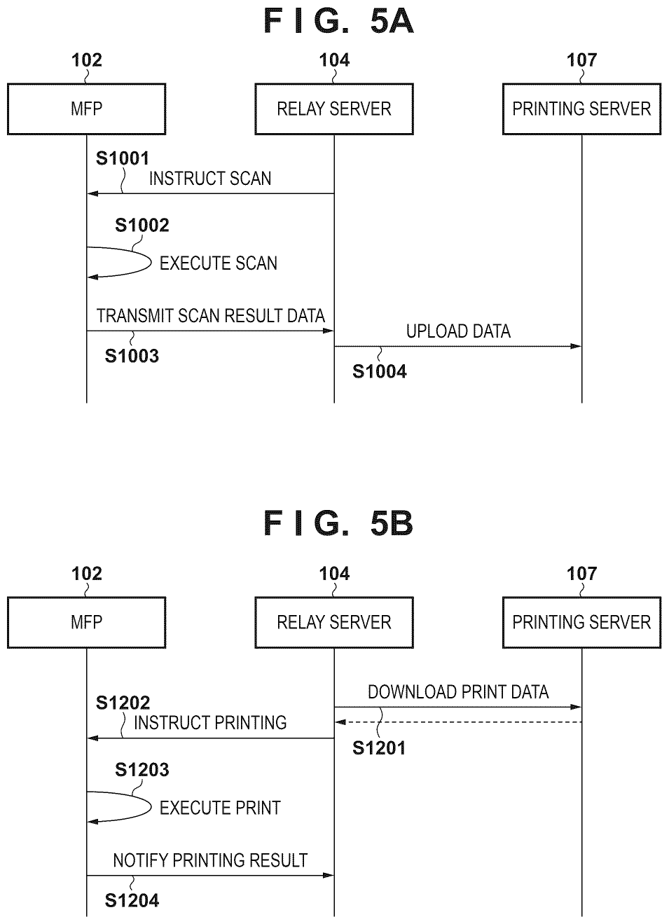

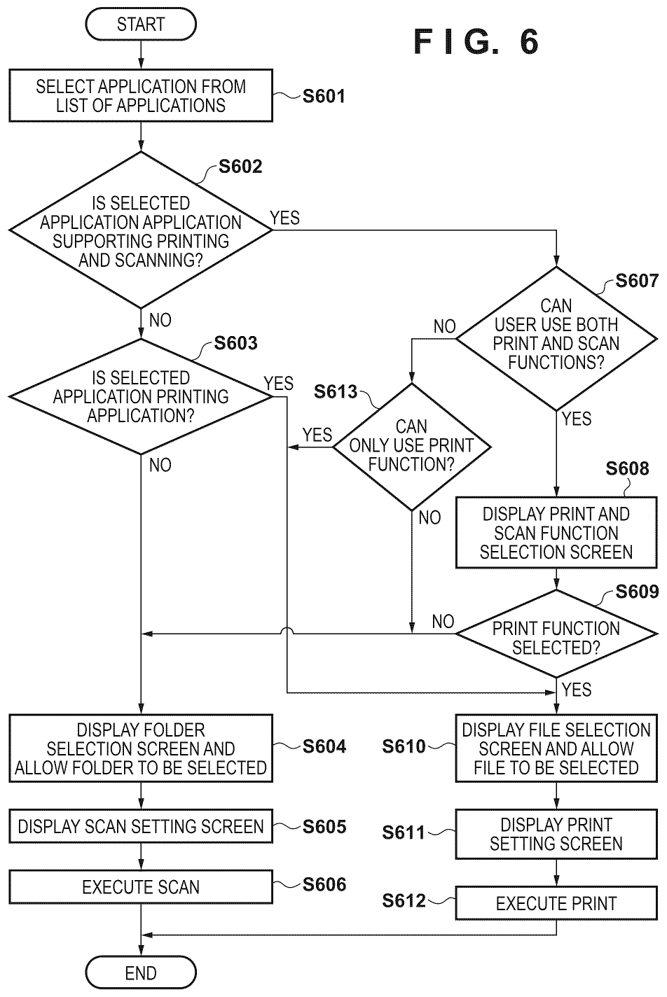

When the user operates an execute scan button 905, the client apparatus 101 notifies the relay server 104 of information indicating that the execute scan button 905 has been operated. In response to this, processing for uploading scan data indicated in FIG. 5A is started.

Processing for uploading scan data will be described with reference to FIG. 5A.

In step S1001, the relay server 104 transmits a scan instruction to the MFP 102 according to scan setting parameters set by the user on a scan setting screen 900. Upon receiving the scan instruction from the relay server 104, the MFP 102 performs (step S1002) scanning according to the designated scan setting parameters and transmits (step S1003) scan result data to the relay server 104.

The relay server 104 uploads (step S1004) binary data of the scan result received from the MFP 102 to the printing server 107, which is a storage server associated with the account, using the access token obtained in step S709 of FIG. 7. The information on the folder selected by the user on the folder and file list display screen 800 of FIG. 4C is transmitted together therewith to the printing server 107, and an instruction is issued so as to store the uploaded scan data into the folder selected by the user.

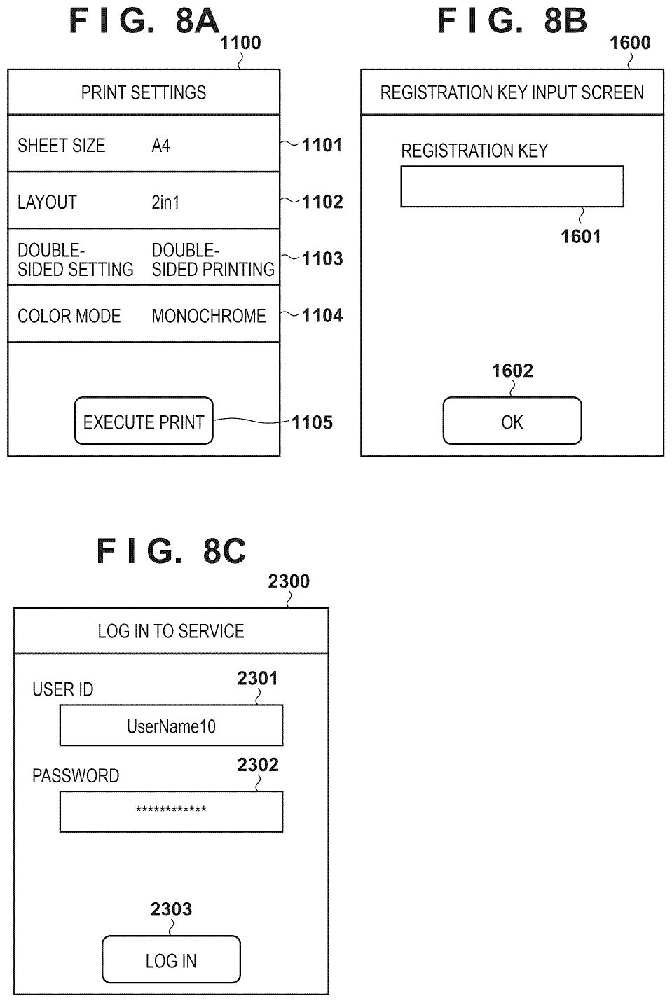

When the enter button 806 is operated in FIG. 4C at execution of the print function, a screen for performing print settings of FIG. 8A is transitioned to. In FIG. 8A, a sheet size (1101), a print layout (1102), a double-sided setting (1103), and a color mode (1104) are exemplified as items that can be set for printing. A print setting item may be any item so long as it is an item that can be set in the MFP 102, and in a case where printing is executed in a state which the values of all items are fixed, a configuration in which no setting is performed may be taken.

When the user operates an execute printing button 1105 in FIG. 8A, the client apparatus 101 notifies the relay server 104 of information indicating that the execute printing button has been operated. In response to this, print processing indicated in FIG. 5B is started.

The print processing will be described referring to FIG. 5B. In step S1201, the relay server 104 requests to download print data for executing printing from the printing server 107. Upon completion of download of the print data, the relay server 104 issues (step S1202) a print instruction to the MFP 102 using the print settings set in a print setting screen 1100 and the print data downloaded in step S1201.

Upon receiving the print instruction from the relay server 104, the MFP 102 executes (step S1203) printing in accordance with the designated print setting parameters. Upon completing printing, the MFP 102 transmits (step S1204) a printing result to the relay server 104, such as whether printing was successful or resulted in an error or the user has performed cancellation during printing. The printing result notification may include information by which it is possible to estimate how much consumables have been used, such as the number of printed pages, whether color or monochrome printing has been performed, and whether double-sided printing has been performed. If the user has performed cancellation during printing, information as to those for which printing was executed is transmitted to the relay server 104.

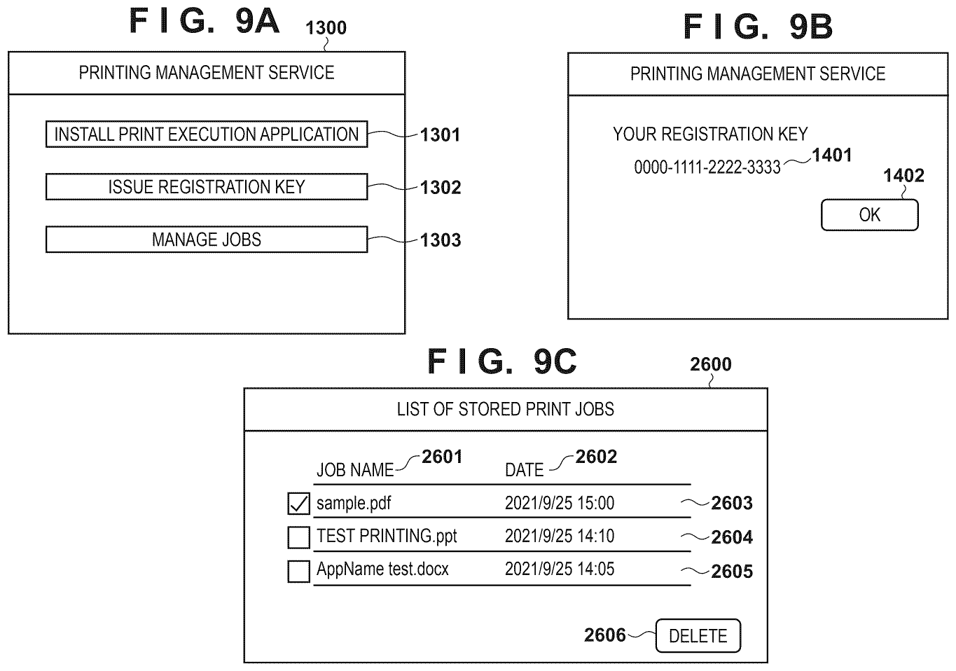

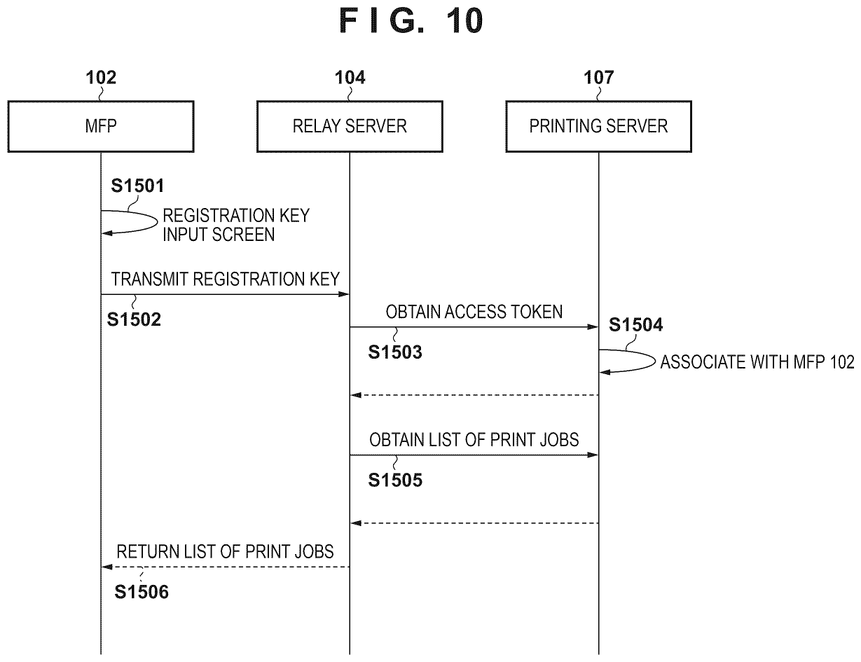

Next, a management function of a printing management service according to the present embodiment will be described with reference to FIGS. 9A to 9C. The printing management service is a service that is provided by the printing server 107 and capable of managing print jobs submitted to the printing server 107, receiving results of performing printing in the MFP 102 via the relay server 104, and managing printing results.

FIG. 9A is an example of a menu screen of the management function of the printing management service. The management function is provided by the user directly accessing the service application 108 of the printing server 107 from the web browser of the client apparatus 101. The user uses the management function by using the display unit 305 and the operation unit 306 of the client apparatus 101. It is assumed that the user has registered in advance an account of the printing server 107 and can use the management function by performing an authentication operation. The mobile terminal 109 may be used instead of the client apparatus 101.

A menu screen 1300 includes respective buttons, which are “install a print execution application” (1301), “issue a registration key” (1302), and “manage jobs” (1303). When information indicating that any one of these buttons has been selected by the user is obtained, a function screen corresponding to a respective button is displayed.

When the user selects the install a print execution application button (1301), an installer file for installing an application for transmitting a print job to the printing management service can be downloaded to the client apparatus 101.

FIG. 9B is an example of a screen for displaying a registration key in the printing management service. It is displayed on the web browser of the client apparatus 101 when the user selects the issue a registration key button 1302 on the menu screen 1300 of FIG. 9A. The present screen is for displaying a registration key 1401 for associating the MFP 102 with a user account of the printing management service.

It is assumed that the registration key in the present embodiment is constituted by a random 16-digit numerical value and can uniquely identify an account of a user of the printing management service. The user associates the MFP 102 with the user account by inputting a registration key on a registration key input screen of FIG. 8B to be described later. In the registration key display screen, a numerical value is displayed so as to be separated by a hyphen every four digits in consideration of readability by the user. The registration key may be provided with a validity period, such as 30 minutes, and may be made invalid after the validity period has been reached. By an OK button 1402 being operated, the present screen is closed, and the management function menu screen illustrated in FIG. 9A is returned to.

Next, processing for when the user uses the printing management service by using the MFP 102 will be described with reference to FIG. 10. FIG. 10 is a sequence diagram for displaying, on the display unit 305 of the MFP 102, a screen for selecting a list of print jobs held by the user in the printing management service. The CPU 205 of the MFP 102 reads the application 214 stored in the program memory 206 into the work memory 207 and runs the application 214 and thereby controls each unit and performs processing.

First, upon obtaining an instruction to activate an application for using the printing management service according to the operation unit 306 of the MFP 102, the MFP 102 displays (step S1501) a registration key input screen 1600 illustrated in FIG. 8B on the display unit 305.

In the registration key input screen 1600 illustrated in FIG. 8B, a registration key input field 1601 is for inputting a registration key displayed on the registration key display screen of FIG. 9B. In the operation unit 306, input of a registration key from the user is obtained, and it is determined that the OK button 1602 has been operated. Then, the inputted registration key is transmitted (step S1502) to the relay server 104. The relay server 104 transmits information of the registration key and information of the MFP 102 to the printing server 107 and obtains (step S1503) an access token necessary for obtaining a list of print jobs. Here, the information of the MFP 102 includes information such as a product name of the MFP 102 and a serial number for uniquely identifying the MFP 102.

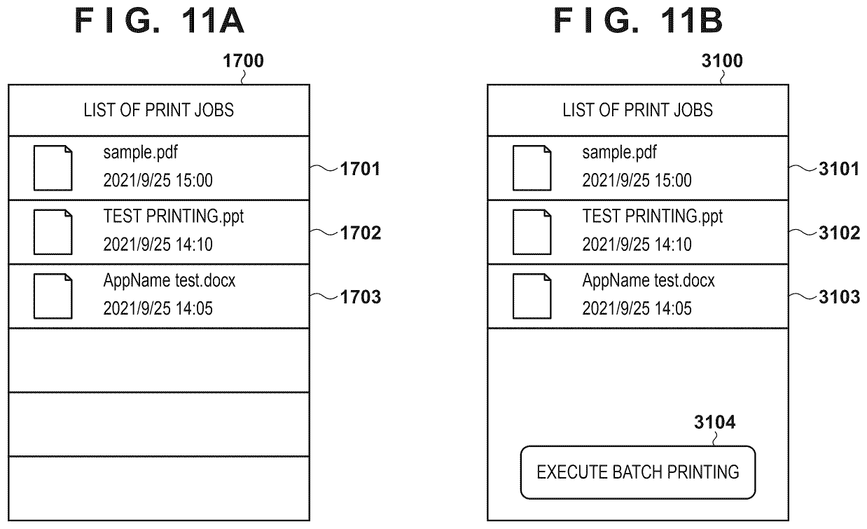

In step S1504, the printing server 107 verifies the registration key received from the relay server 104, identifies a user account, and manages the user account and the received information of the MFP 102 in association with each other. The relay server 104 obtains (step S1505) a list of print jobs associated with the authenticated account from the printing server 107 using the obtained access token and returns (step S1506) the list of print jobs to the MFP 102. The MFP 102 generates a screen for displaying print jobs on the display unit 305 and displays a print job list screen 1700 illustrated in FIG. 11A.

Reference numerals 1701, 1702, and 1703 of FIG. 11A each indicate a print job submitted to and managed by the printing server 107. For each item, an icon, a job name of the print job, and information on the date and time at which the print job was submitted are displayed. It is conceivable that the icon is an icon by which a print job target file type can be identified. Here, a method for submitting a print job to the printing server 107 in the printing management service according to the present embodiment will be described.

As described above, by selecting the install a print execution application button (1301) in FIG. 9A, an application for transmitting a print job to the printing management service can be installed on the client apparatus 101. At this time, a printer driver is installed on the client apparatus 101 at the same time as the application. The user performs a print operation for a file that they want to print in an application that they normally use in the client apparatus 101. Then, by selecting the printer driver installed and executing printing by the above-described operation, a print job for using the printing management service is submitted. The application for submitting a print job to the printing management service is not limited to being installed on the client apparatus 101 and may be installed on the mobile terminal 109.

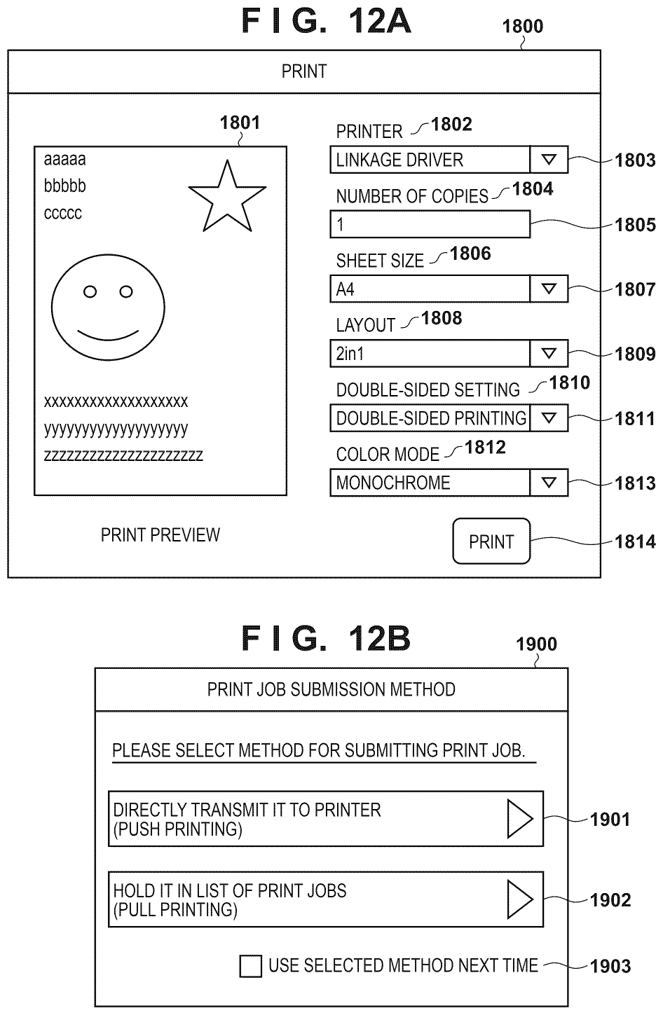

FIG. 12A is an example of a print dialog for when the user has performed a print operation from any application on the client apparatus 101. Reference numeral 1801 is a print preview in which the contents of a file to be printed by the user are displayed in a preview. The preview contents may be dynamically updated according to print setting values to be described later. A printer item 1802 is an item for setting a printer driver for executing print processing. It is conceivable to assume a format, such as a combo box as indicated by reference numeral 1803, the format in which a list of printer drivers currently installed on the client apparatus 101 are displayed and any one of them can be selected. Here, it is assumed that a printer driver named “linkage driver” is a driver for establishing linkage with the printing management service in the present embodiment. The mobile terminal 109 may be used instead of the client apparatus 101.

In the item of the number of copies 1804, the number of copies to be printed is inputted using an integer value. Reference numeral 1805 adopts a form in which the user inputs a numerical value as a text box format but may adopt, for example, a form in which a numerical value is selected using a combo box, a form in which a numerical value can be changed using a spin box, or the like. In FIG. 12A, a sheet size 1806, a layout 1808, a double-sided setting 1810, and a color mode 1812 are exemplified as other items for which print setting can be performed. In a combo box 1807, a sheet size such as A4, Letter, or B5 is set. In a combo box 1809, a layout such as 1in1, 2in1, or 4in1 is set. In a combo box 1811, single-sided printing or double-sided printing is set. In a combo box 1813, monochrome or color is set. The print setting items and setting values displayed here are examples, and any setting item and selection format may be adopted. Further, when a print button 1814 is operated after print setting desired by the user is performed, a print job is confirmed.

When the user operates the print button 1814, print data generation processing is performed by the printer driver. Then, an “application for transmitting a print job” installed on the client apparatus 101 is activated, and a screen for selecting a print job submission method illustrated in FIG. 12B is displayed. In a print job submission method selection screen 1900, it is possible for the user to select how a job to be printed will be submitted. When an option 1901 is selected, a print job is submitted in a “push-printing” format in which the print job is immediately transmitted to the printer and printed. That is, a print job is transmitted to the MFP 102 registered in the sequence of FIG. 10 and is immediately printed.

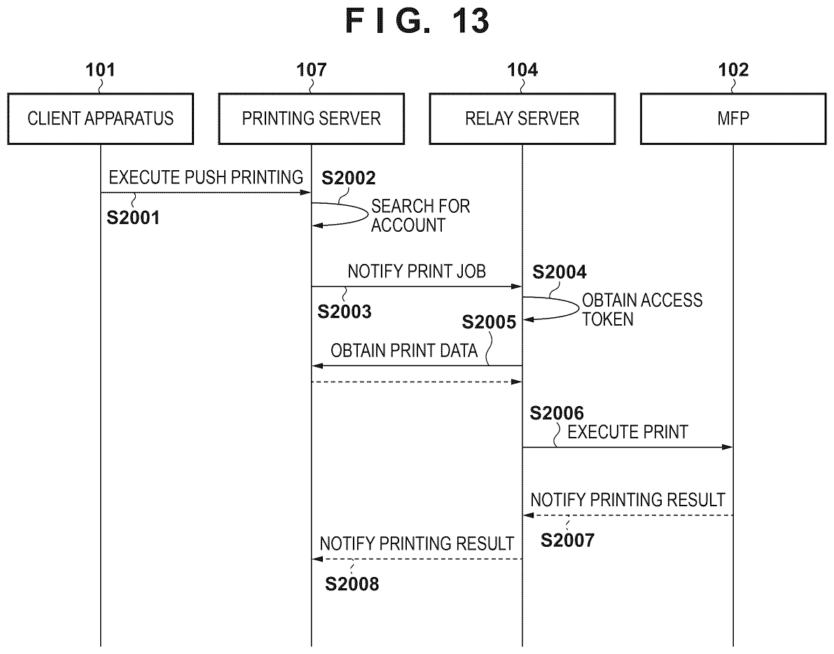

The push-printing processing will be described with reference to FIG. 13. When the user selects the option 1901 on the screen for selecting a print job submission method of FIG. 12B, the client apparatus 101 transmits (step S2001) a push-printing execution request to the printing server 107. At this time, a print file associated with the print job is uploaded and print setting values are transmitted at the same time. Then, the printing server 107 obtains (step S2002) information on which account the request processing is by, information of the MFP 102 registered in that account, and the like based on the push-printing execution request received from the client apparatus 101. The mobile terminal 109 may be used instead of the client apparatus 101.

As the account identification method, the printing server 107 may obtain account information from the client apparatus 101. In addition, when installing the “application for transmitting a print job”, the client apparatus 101 accesses the service application 108 provided by the printing server 107 and performs login processing. Information such as an access token obtained at this time is held in the application. When requesting the printing server 107 to execute push printing, the client apparatus 101 may write and transmit the access token in a request header.

Then, the printing server 107 transmits (step S2003) a print job notification to the relay server 104 together with the found account information, the information of the MFP 102 registered in the account, and the information associated with the print job at the time of the push print request. The relay server 104 obtains (step S2004) an access token for transmitting a request to the printing server 107 based on the information associated with the print job received from the printing server 107 and obtains (step S2005) print data.

Here, a configuration may be taken such that the relay server 104 returns an error to the printing server 107 when it is determined that the access token is invalid due to being expired, when the access token itself is not present, and the like. In FIG. 13, a form in which print data is obtained by the printing server 107 from the relay server 104 in step S2005 has been described, but any method may be used so long as the printing server 107 can obtain the print data. For example, the binary data of the print data may be added to the print job notification request of step S2003.

Then, upon obtaining print data, the relay server 104 issues (step S2006) a print execution instruction to the MFP 102. Here, the print execution instruction for the MFP 102 includes information of a print file associated with the print job and print setting values set in a print screen 1800 of FIG. 12A. Then, upon completing execution of printing, the MFP 102 notifies (step S2007) the relay server 104 of a printing result. Further, the relay server 104 notifies (step S2008) the printing server 107 of the printing result.

Next, pull printing of the present embodiment will be described.

When the user performs an operation for selecting an option 1902 on the print job submission method selection screen 1900 of FIG. 12B, rather than immediately performing print execution for the print job, the print job is submitted in a “pull-printing” format in which the print job is added to a list of print jobs managed by the printing server 107. The submitted print job is stored in the disk apparatus 302 of the printing server 107 until a print execution instruction is issued. In the pull printing of the present embodiment, when the print job is submitted to the printing server 107, the push notification service 106 of the relay server 104 performs push notification of a message indicating that the print job has been submitted to the mobile terminal 109. Thus, the mobile terminal 109 can instruct selection of a print job and execution of printing. The print job may be submitted from the mobile terminal 109 instead of the client apparatus 101.

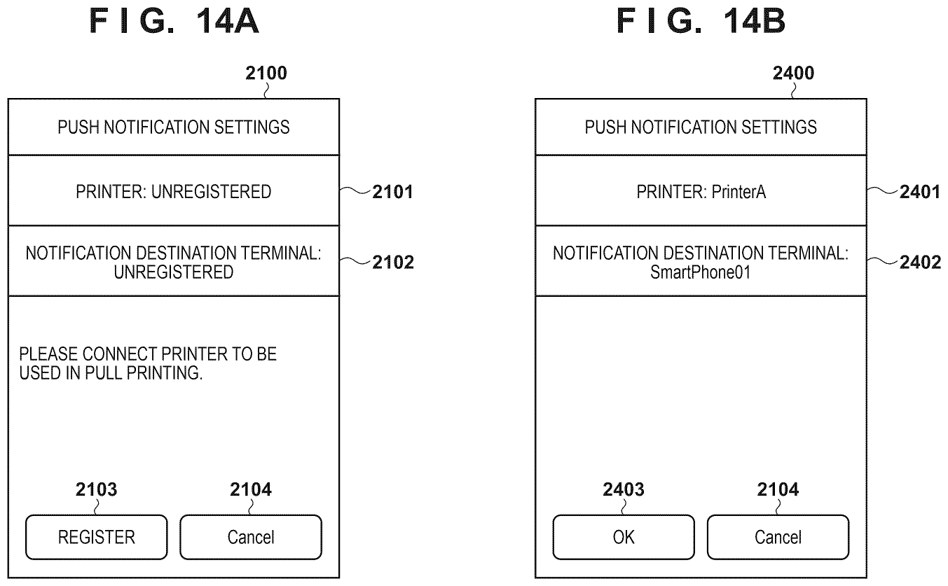

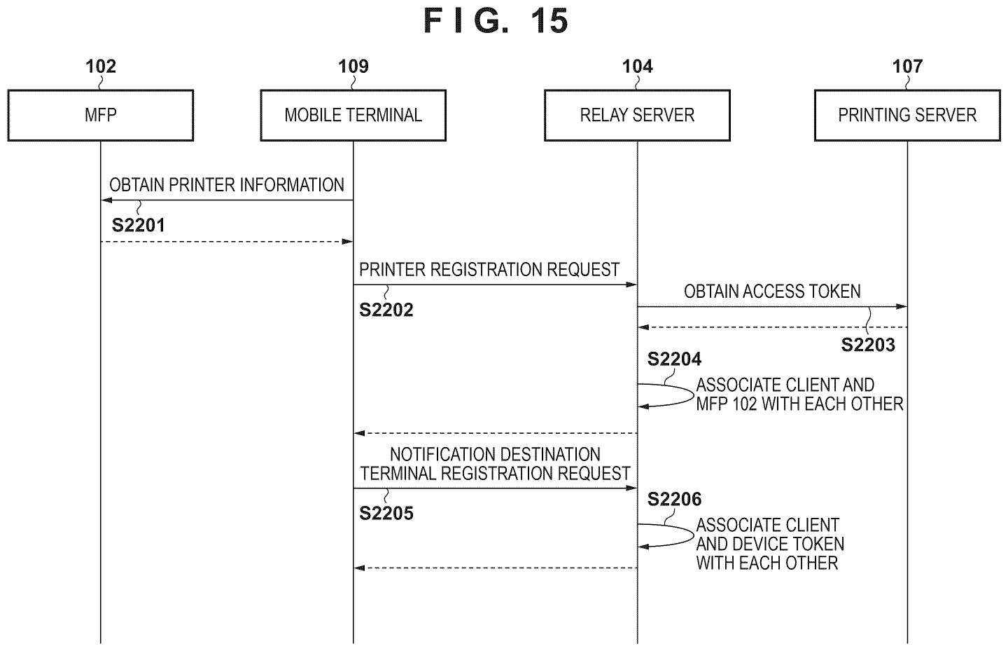

In order for the relay server 104 to perform push notification to the mobile terminal 109, it is necessary to perform registration processing for push notification in advance. In the registration processing, first, the “pull-printing application” of the mobile terminal 109 is activated, and a push notification setting screen 2100 illustrated in FIG. 14A is displayed. In the push notification setting screen 2100, “unregistered” is displayed because a printer 2101 that is to execute the pull printing and a notification destination terminal 2102 for push notification are not registered in the initial setting. Here, when a register button 2103 is operated, it is possible to perform processing for registering a printer that is to execute pull printing and a notification destination terminal for push notification in the relay server 104. When a cancel button 2104 is operated, the screen is closed without the registration processing being performed.

Processing for when the register button 2103 is operated in FIG. 14A will be described with reference to FIG. 15. The pull-printing application of the mobile terminal 109 communicates with the MFP 102 over the network 103 and obtains (step S2201) printer information. The printer information includes information such as a product name of the MFP 102 and a serial number for uniquely identifying the MFP. The mobile terminal 109 transmits the obtained printer information to the relay server 104 and makes (step S2202) a printer registration request. Upon receiving the printer registration request from the mobile terminal 109, the relay server 104 obtains (step S2203) an access token from the printing server 107.

When the access token itself is not present or the access token is not valid, the mobile terminal 109 displays a service login screen 2300 illustrated in FIG. 8C. The user inputs a user ID 2301 and a password 2302 necessary for logging in to the service and selects a login button 2303 to perform a login operation. When the login is successful, the relay server 104 stores (step S2204) the access token and the MFP 102 in the database 313 in association with each other as the client information.

Upon receiving a response to the printer registration request, the mobile terminal 109 makes (step S2205) a request for registering a notification destination terminal for the push notification service 106 to the relay server 104. It is assumed that an address and a server name of the relay server 104 used as an address of a transmission destination of the registration information are stored in advance in the pull-printing application of the mobile terminal 109. The notification destination terminal information is identification information of the mobile terminal 109 and includes, for example, a device token necessary for receiving a push notification and information on the OS (type of OS, version of OS, and the like) installed on the mobile terminal 109.

The device token is information provided by the OS when the OS installed on the mobile terminal 109 is iOS and uniquely identifies the terminal to which a push notification is to be transmitted. The device token includes, for example, identification information of an application of the mobile terminal 109. When the OS of the mobile terminal 109 is Android, it is referred to as a registration token, but in the present embodiment, description will be given using the device token as an example. Upon receiving the notification destination terminal information from the mobile terminal 109, the push notification service 106 of the relay server 104 stores (step S2206) the above-described client information and device token in the database 313 in association with each other.

With this, a user account, a printer that executes pull printing, and a push notification communication destination terminal are registered in the relay server 104 in association with each other. The relay server 104 can recognize to which mobile terminal 109 the pull printing execution information received from the “application for transmitting a print job” of the client apparatus 101 should be transmitted. With the above, the registration processing for push notification is completed.

When the setting screen is displayed again after the completion of the registration, a push notification setting screen 2400 illustrated in FIG. 14B is displayed, and setting information 2401 of a printer that executes pull printing and setting information 2402 of a notification destination terminal for push notification can be confirmed. For example, it may be possible to perform re-registration by changing the contents of the setting information 2401 of the printer on the screen and operating an OK button 2403.

A method for transmitting registration information in registration processing is not particularly limited. For example, it may be an HTTP method in which registration information is converted into an HTML format and transmitted or an FTP method in which registration information is created in a file format and the file is transmitted. The registration information may be data encrypted using a security key shared by the push notification service 106 and the application of the mobile terminal 109. In addition, the data may be binary data, text data such as UTF-8, or data encoded using a method such as Base64.

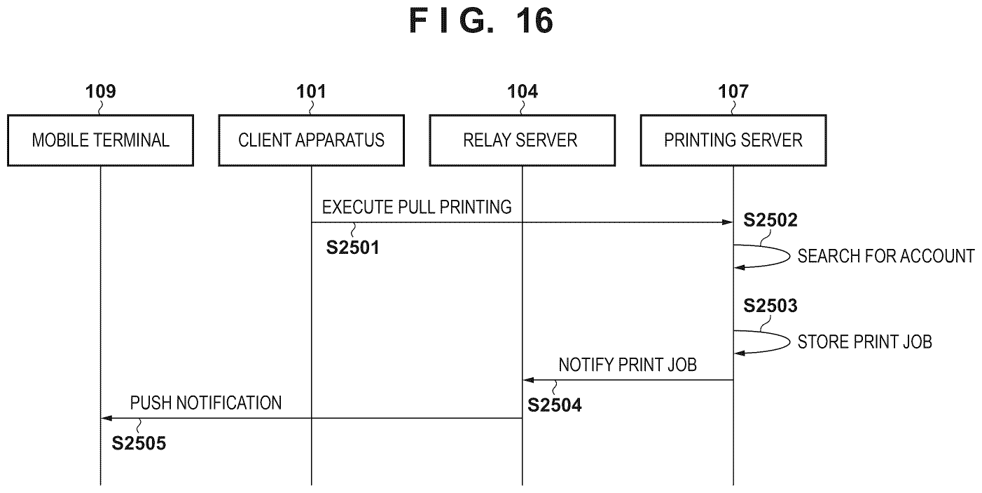

Processing for the option 1902 being selected in the print job submission method selection screen 1900 of the client apparatus 101 of FIG. 12B, submitting a print job in the “pull-printing” format, and performing push notification to the mobile terminal 109 will be described with reference to FIG. 16.

When the user selects the option 1902 in the selection screen 1900 of FIG. 12B, the client apparatus 101 transmits (step S2501) a pull-printing execution request to the printing server 107. At this time, a print file associated with the print job is uploaded and print setting values are transmitted at the same time. Then, the printing server 107 obtains (step S2502) information on which account the request processing is by, based on the received pull-printing execution request.

As the account identification method, the printing server 107 may obtain account information from the client apparatus 101. In addition, when installing the “application for transmitting a print job”, the client apparatus 101 may use an access token obtained by accessing the service application 108 provided by the printing server 107 and performing login processing. A configuration may be taken such that information such as the obtained access token is held in the application of the client apparatus 101 and the access token is written in a request header and transmitted to the printing server 107 at the time of pull-printing execution request. So long as the printing server 107 can identify the account information from the information, the information is not limited to the access token and may be any information.

Next, the printing server 107 stores (step S2503) the information associated with the print job at the time of pull-printing request in association with the found account information.

A list of print jobs for pull printing stored in this way can be confirmed by operating the manage jobs button 1303 on the menu screen 1300 of the client apparatus 101 illustrated in FIG. 9A. An example of a screen to be displayed when the user operates the manage jobs button 1303 is illustrated in FIG. 9C. In the screen of FIG. 9C, a list of print jobs stored by the user is displayed, and a job name 2601 of the print job and a date 2602 on which the print job was submitted are displayed in a list. The items displayed here are not limited to these, and other information may be displayed so long as it is information associated with the print job. For example, it is conceivable to display a print setting value associated with the print job, the number of pages of the print file, and the like.

A check box is assigned to each print job in the list of print jobs, and by operating a delete button 2606 while the check box is checked, a print job can be deleted. In the list screen illustrated in FIG. 9C, a print job 2603 whose job name is “sample.pdf” is in a state in which it is checked. When the delete button 2606 is operated in this state, only the print job 2603 is deleted, and the print jobs are displayed again in a list in a state in which the print jobs 2604 and 2605 remain.

A configuration in which a validity period is set for a print job and the print job is automatically deleted when the validity period has elapsed without the user intentionally deleting the print job may be taken. A configuration may be taken so as to allow only the account administrator to set the validity period.

Returning to FIG. 16, after the print job has been stored, the printing server 107 notifies (step S2504) the relay server 104 that the print job has been submitted. The push notification service 106 of the relay server 104 performs (step S2505) push notification of a message indicating that the print job has been submitted to the mobile terminal 109. Upon receiving notification information from the relay server 104, the mobile terminal 109 uses the push notification function to display a notification region (push notification region) for notifying the user of a message corresponding to the notification information in the screen displayed by the display unit 305.

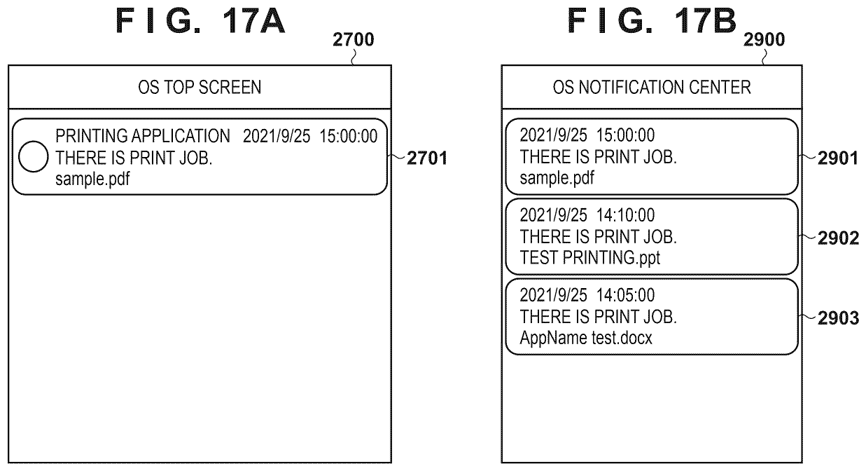

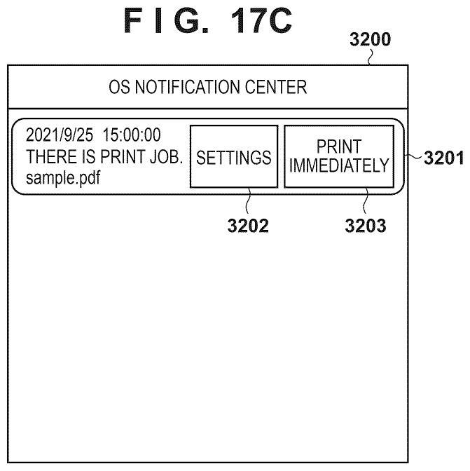

FIG. 17A is an example of a screen in a state in which a message is displayed in a notification region by the push notification function. A top screen 2700 of the OS indicates the largest region that can be displayed by the display unit 305, and a notification region 2701 indicates a region for notifying a message corresponding to the notification information. In the present embodiment, the push notification function of displaying the notification region 2701 on the display unit according to a push notification is realized by the OS installed on the mobile terminal 109.

The push notification function is a function capable of sending a notification to an application on the mobile terminal 109 even in a state where that application is not activated. That is, the notification region 2701 can be displayed by the push notification function of the mobile terminal 109 even in a state in which an application of the mobile terminal 109 is operating in the background, a state in which the application is not activated, or a state in which a home screen is displayed.

A message corresponding to notification information may include print job information, account information, and a URL in addition to text of a display message. The notification region 2701 includes a name or icon of the application, a notification time, and a display message, each being an item related to notification information. The notification time indicates information on the date and time at which the notification information was received. With this, the user can easily ascertain when and what kind of push notification has been made.

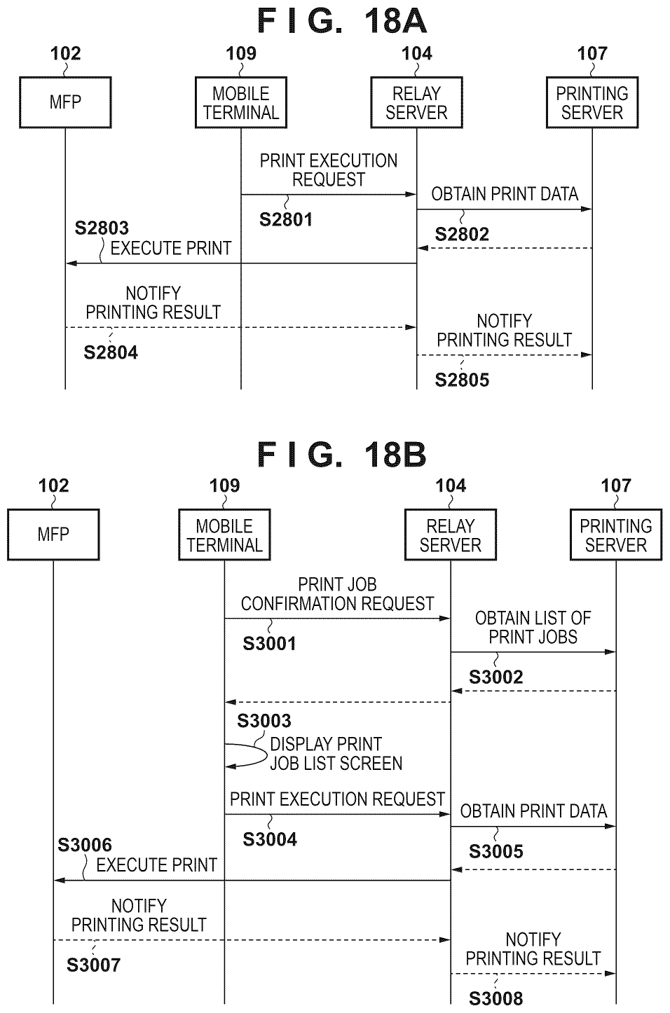

FIG. 18A is a sequence diagram for when the user selects notification information of a push notification and executes a pull-printing print job in the mobile terminal 109. When the notification region 2701 is selected and operated by the user in FIG. 17A, the OS of the mobile terminal 109 analyzes notification information and activates an application registered in the push notification service. Since the notification information includes information of the application corresponding to the notification information, the OS can identify to which application it corresponds. The notification information includes print job information and account information, and the activated application can obtain that information.

The application of the mobile terminal 109 transmits (step S2801) a print execution request to the relay server 104. The print execution request includes print job information, account information, and printer information for executing printing set in the application. After verifying the account information, the relay server 104 obtains (step S2802) print data and print setting information associated with the print job information from the printing server 107. The printer information need not necessarily be included in the print execution request, and information registered in the relay server 104 may be used.

In this way, the account information and the print job information are included in the print execution request from the mobile terminal 109 to the relay server 104. With this, the mobile terminal 109 can skip the service login screen of FIG. 8C, the print job list selection screen of FIG. 11A, and the print setting screen of FIG. 8A. A configuration may be taken such that, in the mobile terminal 109, the print setting screen of FIG. 8A is displayed, and after print settings have been changed, a start request of the print button is accepted.

The relay server 104 instructs (step S2803) the MFP 102 to execute printing based on the print data and the print setting information obtained through the print execution request from the mobile terminal 109. Upon completing print execution, the MFP 102 notifies (step S2804) the relay server 104 of a printing result, and the relay server 104 further notifies (step S2805) the printing server 107 of the printing result. With this form, the user can execute a pull-printing job by a simple operation of tapping a push notification displayed on the mobile terminal 109.

FIG. 17B is an example of a screen in a state in which messages related to a plurality of print jobs are displayed in notification regions by the push notification function in the mobile terminal 109. The OS of the mobile terminal 109 includes a function of displaying a push notification on a notification center screen 2900. The notification center screen 2900 of the OS indicates the largest region that can be displayed by the display unit 305, and notification regions 2901 to 2903 indicate regions for notifying the user of a message corresponding to notification information. The notification regions 2901 to 2903 include a name or icon of the application, a notification time, and a display message, each being an item related to notification information. The notification time indicates information on the date and time at which the notification information was received, and recent notification messages that have been received are displayed in descending order from the top of the notification center screen 2900 of the OS.

The OS of the mobile terminal 109 performs display control of the notification center screen 2900. The OS of the mobile terminal 109 can display a plurality of notification messages in an ascending order in a list or display similar notification messages in a single group. In addition, a configuration may be taken such that even in a state in which the screen of the mobile terminal 109 is locked, the OS displays a push notification message in a notification region and request unlocking when the user performs a selection operation.

A sequence for when in the mobile terminal 109 the user selects a message in the notification region 2901 from the plurality of notification messages of push notification of FIG. 17B and executes a pull-printing print job is indicated in FIG. 18B. When the notification region 2901 is selected and operated by the user, the OS of the mobile terminal 109 analyzes notification information and activates an application registered in the push notification service. The notification information includes account information, and the activated application can obtain that information.

An application of the mobile terminal 109 transmits (step S3001) a print job confirmation request to the relay server 104. The print job confirmation request includes account information and print target printer information set by the application. After verifying the account information, the relay server 104 obtains (step S3002) a list of print jobs associated with the account information and causes (step S3003) the mobile terminal 109 to display the print job list screen illustrated in FIG. 11B. In the mobile terminal 109, the user selects a job to be printed and thereby transitions to the print setting screen illustrated in FIG. 8A. In the print setting screen, the user operates the execute printing button 1105 to transmit (step S3004) a print execution request to the relay server 104. The printer information need not necessarily be included in the print job confirmation request, and information registered in the relay server 104 may be used.

The print execution request includes information on the print job selected by the user. The relay server 104 obtains (step S3005) print data and print setting information associated with the print job information from the printing server 107. By including the account information in the print job confirmation request as described above, the mobile terminal 109 can skip the service login screen of FIG. 8C.

The relay server 104 instructs (step S3006) the MFP 102 to execute printing based on the print data and the print setting information obtained through the print execution request from the mobile terminal 109. Upon completing print execution, the MFP 102 notifies (step S3007) the relay server 104 of a printing result, and the relay server 104 further notifies (step S3008) the printing server 107 of the printing result.

The print jobs of the plurality of notification messages of the push notification correspond to the respective jobs on the print job list screen of the mobile terminal 109 illustrated in FIG. 11B. Therefore, when it is desired that all the jobs be printed in a single operation, by an execute batch printing button 3104 being operated, the relay server 104 can print all the jobs by repeatedly instructing the MFP 102 to execute printing for each job. Of course, a configuration may be taken such that a check box for selecting a respective job is provided in the print job list screen illustrated in FIG. 11B and the user can select any plurality of jobs. With this form, the user can cause a pull-printing job selection screen to be displayed with a simple operation of tapping a push notification displayed on the mobile terminal 109.

The OS installed on the mobile terminal 109 may include a custom action function for the notification center. For example, FIG. 17C illustrates a notification center screen 3200 of the OS. A setting button 3202 and a print immediately button 3203 are provided in a notification region 3201 of the push notification. A configuration may be taken such that the user, by performing a selection operation on the setting button 3202, can display the print setting screen illustrated in FIG. 8A and perform print setting and, by performing a selection operation on the print immediately button 3203, can give a print execution instruction without transitioning to the print setting screen.

### Second Embodiment

The above first embodiment realizes pull printing by not immediately executing a print job and adding the print job to a list of print jobs managed by the printing server 107. In pull printing of the above first embodiment, the push notification service 106 of the relay server 104 performs push notification of a message indicating that a print job has been submitted to the mobile terminal 109, and thereby, print job selection and print execution are instructed from the mobile terminal 109.

In pull printing of a second embodiment, after a print job is added to a list of print jobs managed by the printing server 107, a “print code” for identifying the print job information is issued. When starting printing from the mobile terminal 109, the user inputs a print code to execute printing. The configuration of the pull-printing system including the relay server 104 according to the present embodiment is similar to that of FIG. 1 described in the first embodiment.

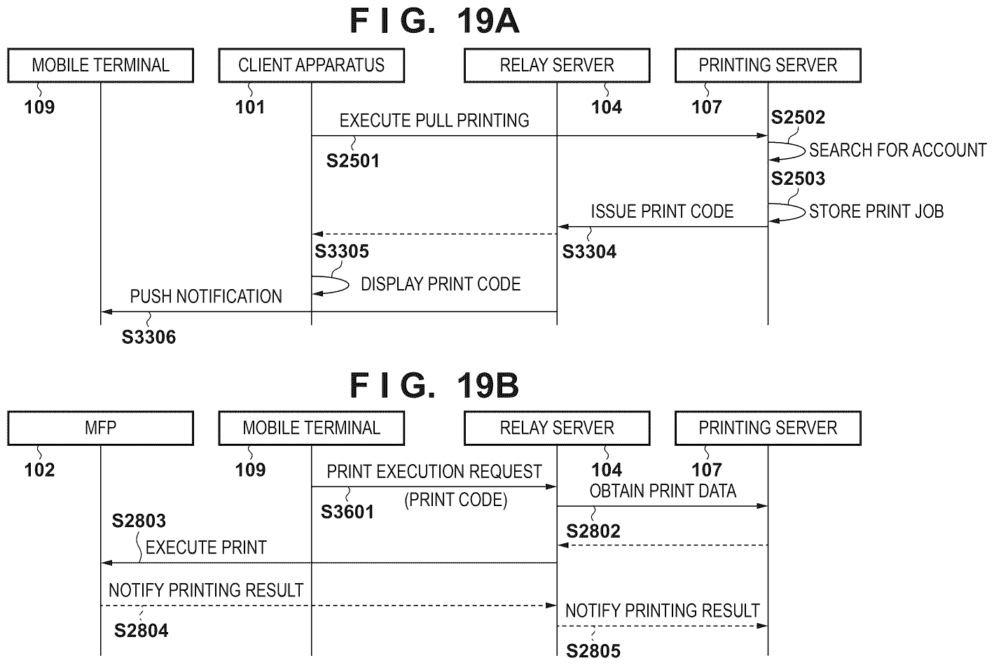

A sequence of the present embodiment will be described with reference to FIG. 19A. FIG. 19A illustrates a processing sequence from when a selection operation is performed on the option 1902 in the print job submission method selection screen 1900 of FIG. 12B and a print job is submitted in the “pull-printing” format to when push notification is performed to the mobile terminal 109. Processes similar to that in FIG. 16 of the first embodiment will be given the same step numerals.

When the user performs a selection operation on the option 1902 in the print job submission method selection screen 1900 of the client apparatus 101 of FIG. 12B, the client apparatus 101 transmits (step S2501) a pull-printing execution request to the printing server 107. At this time, a print file associated with the print job is uploaded and print setting values are transmitted at the same time. Then, the printing server 107 obtains (step S2502) information on which account the request processing is by, based on the pull-printing execution request received from the client apparatus 101. Then, the printing server 107 stores (step S2503) the information associated with the print job at the time of pull-printing request in association with the found account information.

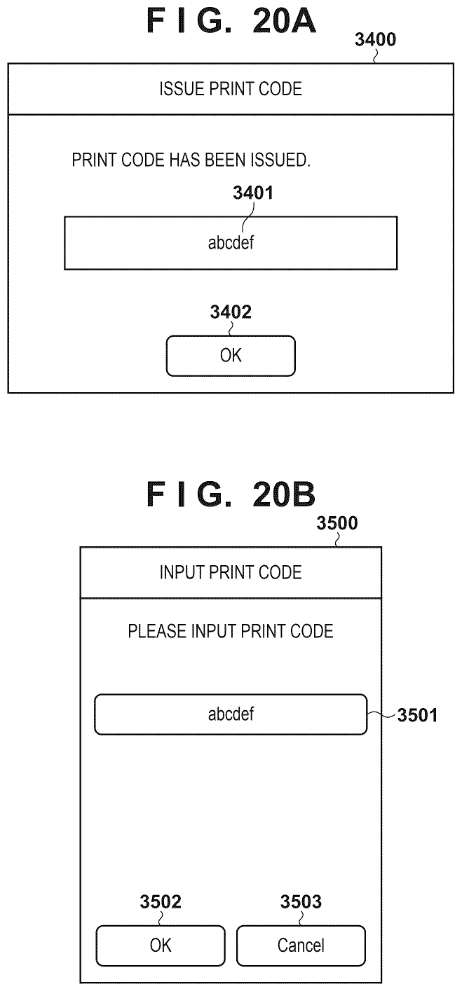

Then, after storing the print job, the printing server 107 issues (step S3304) a “print code” that uniquely identifies job information. The issued “print code” is transmitted to the client apparatus 101 via the relay server 104, and the client apparatus 101 displays (step S3305) a print code issuance screen 3400 illustrated in FIG. 20A on the display unit 305. For example, the print code is a six-digit alphanumeric code and is displayed in a print code display region 3401 of the client apparatus 101. A configuration may be taken such that a validity period is set for the print code and the print job is automatically deleted when the validity period has elapsed. When an OK button 3402 is operated in FIG. 20A, the present screen is closed.

Next, the push notification service 106 of the relay server 104 performs (step S3306) push notification of a message indicating that the print job has been submitted to the mobile terminal 109. Upon receiving the notification information from the relay server 104, the mobile terminal 109 displays a notification message in the notification region.

Next, FIG. 19B illustrates a sequence in which the user selects notification information of a push notification and executes a pull-printing print job. Processes similar to that in FIG. 18A of the first embodiment will be given the same step numerals.

When the user performs a selection operation on the notification region 2701 of FIG. 17A in the mobile terminal 109, the OS analyzes notification information and activates an application registered in the push notification service. In this case, in the mobile terminal 109, the “pull-printing application” is activated, and after the application has been activated, a print code input screen 3500 illustrated in FIG. 20B is displayed, and the user is requested to input a print code. When a print code is inputted by the user, the print setting screen of FIG. 8A is displayed, and after print setting has been performed by the user, when the execute printing button 1105 is operated, a print execution request is transmitted (step S3601) to the relay server 104.

The notification information notified from the relay server 104 to the mobile terminal 109 may include a print code and account information. In this case, the “pull-printing application” of the mobile terminal 109 obtains information of the print job, the print code, and account information at the time of activation. The “pull-printing application” of the mobile terminal 109 transmits (step S3601) a print execution request to the relay server 104. The print execution request includes the obtained print code and account information. It is also possible to include printer information of a print target set by the pull-printing application. The printer information need not necessarily be included in the print execution request, and information registered in the relay server 104 may be used.

After verifying the account information, the relay server 104 obtains (step S2802) print data associated with the print code from the printing server 107. By including the account information and the print code in the print execution request as described above, the service login screen of FIG. 8C, the print code input screen of FIG. 20B, and the print setting screen of FIG. 8A can be skipped in the mobile terminal 109. A configuration may be taken so as to display the print setting screen of FIG. 8A and, by the user operating the execute printing button 11055 after changing the print settings, accept a print execution request.

The relay server 104 instructs (step S2803) the MFP 102 to execute printing based on the print data and the print setting information obtained through the print execution request from the mobile terminal 109. Upon completing print execution, the MFP 102 notifies (step S2804) the relay server 104 of a printing result, and the relay server 104 further notifies (step S2805) the printing server 107 of the printing result.

With this form, the user can execute a pull-printing job by a simple operation of tapping a push notification displayed on the mobile terminal 109. Further, by issuing a print code and including the print code and the account information as notification information for the mobile terminal 109, job selection and print setting need not be performed in the mobile terminal 109.

### Third Embodiment

In the third embodiment, when instructing execution of a print job from the mobile terminal 109, instruction is only allowed when the mobile terminal 109 is near the MFP 102. Hereinafter, the present embodiment will be described. In the present embodiment, the mobile terminal 109 and the MFP 102 each include a Bluetooth control module and can perform communication by Bluetooth.

When the mobile terminal 109 approaches the MFP 102 upon receiving a push notification related to a print job, the CPU 301 of the mobile terminal 109 receives, from the MFP 102, an advertising packet for performing Bluetooth communication. The advertising packet received by the Bluetooth control module of the mobile terminal 109 includes device information indicating the name and functions of the MFP 102, which transmitted the advertising packet, a signal strength value indicating an output strength of the advertising packet, and the like.

The CPU 301 of the mobile terminal 109 obtains the signal strength value included in the advertising packet received from the MFP 102. Next, the CPU 301 of the mobile terminal 109 determines whether the obtained signal strength value is greater than or equal to a predetermined threshold that has been set in advance. For example, a signal strength value of about −70 dBm is set as a predetermined threshold for signal strength.

When the obtained signal strength value is greater than or equal to the predetermined threshold as a result of the determination, it is determined that the mobile terminal 109 is near the MFP 102, and it is possible to instruct print execution by the user performing a selection operation on the notification information of the push notification.

Meanwhile, when the obtained signal strength value is less than the predetermined threshold, it is determined that the mobile terminal 109 is not near the MFP 102, and when the user performs a selection operation on the notification information of the push notification, an error is displayed.

The predetermined threshold for signal strength can be arbitrarily set, and it may be determined that the mobile terminal 109 is near the MFP 102 when an advertising packet is received.

In addition to the signal strength value, it may be determined whether the MFP 102 is registered as a printer to be used in pull printing. According to the present embodiment, when the mobile terminal 109 is not near the MFP 102, it is not possible to issue an instruction to execute a print job from the mobile terminal 109, and thus it is possible to enhance the security of pull printing.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-182052, filed Oct. 23, 2023 which is hereby incorporated by reference herein in its entirety.

What is claimed is:

1. A pull-printing system comprising a printing apparatus, a printing server, and a mobile terminal, the pull-printing system operable to execute printing of a print job, which has been submitted to the printing server, using the printing apparatus, based on an instruction of the mobile terminal,
the printing server comprising:
one or more first memory devices that store a set of instructions; and
one or more first processors that execute the set of instructions to:
receive a print job submitted by a user;
store the print job;
identify the user who submitted the received print job, and transmit information related to the print job in a push notification to a notification destination mobile terminal associated with the user; and
transmit the stored print job to the printing apparatus associated with the identified user, and
the mobile terminal comprising:
a display unit;
one or more second memory devices that store a set of instructions; and
one or more second processors that execute the set of instructions to:
receive the push notification from the printing server; and
in a case where the push notification is received, display a message on the display unit; and
transmit an instruction to execute the print job to the printing server based on a user operation on the message,
wherein the printing server transmitting the print job stored in the printing apparatus is transmitting the print job to the printing apparatus upon receiving an instruction to execute the print job.

2. The pull-printing system according to claim 1, wherein
the message is displayed in the mobile terminal using a notification function provided by an OS of the mobile terminal.

3. The pull-printing system according to claim 1, wherein
the one or more second processors execute instructions in the one or more second memory devices to:
in response to the user operation on the message in the mobile terminal, a pull-printing application of the mobile terminal displays, on the display unit, an operation screen for performing an operation on the print job.

4. The pull-printing system according to claim 1, wherein
the message in the mobile terminal includes information for identifying the print job, and
the one or more second processors execute instructions in the one or more second memory devices to:
cause the pull-printing application of the mobile terminal to display, on the display unit, an operation screen for performing an operation on the print job in the mobile terminal according to the user operation on the message.

5. The pull-printing system according to claim 1, wherein
the one or more second processors execute instructions in the one or more second memory devices to:
in response to the user operation on the message, make a request for obtaining a list of print jobs to the printing server,
the one or more first processors execute instructions in the one or more first memory devices to:
receive the request and transmit a list of print jobs corresponding to the user to the mobile terminal, and
the one or more second processors execute instructions in the one or more second memory devices to:
receive the list of print jobs and display the list of print jobs on the display unit; and
in response to selection of part or all of the list of print jobs by the user, instruct execution of a selected print job.

6. The pull-printing system according to claim 1, wherein
the message in the mobile terminal includes information for identifying the print job, and
the one or more second processors execute instructions in the one or more second memory devices to:
display a setting button and a print button on the display unit; when the setting button is operated by the user, display a setting screen for printing of the print job on the display unit; and when the print button is operated by the user, not display the setting screen on the display unit and transmit an instruction to execute the print job to the printing server.

7. The pull-printing system according to claim 1, wherein
the one or more second processors execute instructions in the one or more second memory devices to:
in a case where the mobile terminal is near the printing apparatus, in response to the user operation on the message in the mobile terminal, cause the pull-printing application of the mobile terminal to display, on the display unit, a screen for performing an operation on the print job,
in a case where the mobile terminal is not near the printing apparatus, in response to the user operation on the message in the mobile terminal, cause the pull-printing application to display an error on the display unit.

8. The pull-printing system according to claim 1, wherein
the one or more first processors execute instructions in the one or more first memory devices to:
upon receiving the print job, issue a print code,
wherein
the storing the print job is storing the print job and the print code in association with each other,
the push notification includes the information related to the print job and the print code, and
the transmitting the print job is transmitting the print job having identified the print job based on the print code.

9. A method for controlling a mobile terminal in a pull-printing system including a printing apparatus, a printing server, and the mobile terminal, wherein the pull-printing system is configured to execute printing of a print job, which has been submitted to the printing server, using the printing apparatus based on an instruction of the mobile terminal,
the method comprising:
receiving, from the printing server, information related to the print job and information for identifying a pull-printing application of the mobile terminal through a push notification;
in a case where the push notification is received, displaying a message on the display unit;
causing the pull-printing application to display, on the display unit, an operation screen for performing an operation on the print job according to a user operation on the message; and
transmitting an instruction to execute the print job to the printing server based on a user operation in the operation screen.

10. A non-transitory computer-readable storage medium, the storage medium storing a program for causing a computer to execute each step of a method for controlling a mobile terminal in a pull-printing system, wherein the pull-printing system includes a printing apparatus, a printing server, and the mobile terminal and is configured to execute printing of a print job, which has been submitted to the printing server, using the printing apparatus, based on an instruction of the mobile terminal
the method comprising:
receiving, from the printing server, information related to the print job and information for identifying a pull-printing application of the mobile terminal through a push notification
in a case where the push notification is received, displaying a message on the display unit;
causing the pull-printing application to display, on the display unit, an operation screen for performing an operation on the print job according to a user operation on the message; and
transmitting an instruction to execute the print job to the printing server based on a user operation in the operation screen.
